(19) United States
(12) Patent Application Publication
(10) Pub. No.: US 2013/0141473 A1
(43) Pub. Date: Jun. 6, 2013

(54) METHOD OF DRIVING DISPLAY PANEL, METHOD OF DISPLAYING THREE-DIMENSIONAL STEREOSCOPIC IMAGE AND DISPLAY APPARATUS FOR PERFORMING THE SAME

(71) Applicants: Gyeong-Ub MOON, Suwon-si (KR); Ga-Na KIM, Seoul (KR); Kyoung-Phil KIM, Cheonan-si (KR); Jung-Hwan CHO, Asan-si (KR); Myeong-Su KIM, Hwaseong-si (KR)

(72) Inventors: Gyeong-Ub MOON, Suwon-si (KR); Ga-Na KIM, Seoul (KR); Kyoung-Phil KIM, Cheonan-si (KR); Jung-Hwan CHO, Asan-si (KR); Myeong-Su KIM, Hwaseong-si (KR)

(73) Assignee: SAMSUNG DISPLAY CO., LTD., Yongin-City (KR)

(21) Appl. No.: 13/530,303

(22) Filed: Jun. 22, 2012

(30) Foreign Application Priority Data
Dec. 6, 2011 (KR) 10-2011-0129710

(51) Int. Cl. G09G 5/10

(52) U.S. Cl. 345/690

(57) ABSTRACT

A method of driving a display panel includes: applying a data signal to the display panel during a sub-active interval based on a data enable signal, and blocking the data signal applied to the display panel during the sub-blanking interval. In such an embodiment, the data enable signal is activated during the sub-active interval and deactivated during the sub-blanking interval, a frame is divided into a plurality of sub-frames, and each of the sub-frames is divided into the sub-active interval and the sub-blanking interval.

This application claims priority to Korean Patent Application No. 10-2011-0129710, filed on Dec. 6, 2011, and all the benefits accruing therefrom under 35 U.S.C. §119, the contents of which in its entirety is herein incorporated by reference.

### BACKGROUND OF THE INVENTION

1. Field of the Invention

Exemplary embodiments of the invention relate to a method of driving a display panel, a method of displaying a three-dimensional stereoscopic image using the method of driving the display panel, and a display apparatus driven by the method of driving the display panel.

2. Discussion of the Related Art

A liquid crystal display (“LCD”) apparatus has been typically used for displaying a two-dimensional (“2D”) image. Recently, a demand for a display device that displays a three-dimensional (“3D”) stereoscopic image is increased in various industrial fields, such as a game device and a film device, for example. Accordingly, an LCD apparatus for displaying a 3D stereoscopic image has been developed.

Generally, a 3D stereoscopic image display apparatus displays the 3D stereoscopic image using a binocular parallax between two eyes of an observer. More particularly, as two eyes of the observer are spaced apart from each other, images respectively viewed by the two eyes at different angles are inputted to the brain of the observer. Thus, the observer may recognize the 3D stereoscopic image through the 3D stereoscopic image display apparatus.

The 3D stereoscopic image may be displayed using various methods such as using extra glasses, or without extra glasses, for example. The stereoscopic type may display the 3D image using polarized glasses or using glasses having shutters.

When the 3D image is displayed using the glasses having the shutters, the shutters of the glasses are selectively closed or opened to display the 3D stereoscopic image. Thus, the observer may recognize the 3D stereoscopic image.

In the display apparatus using the glasses, a cross talk effect, a flicker effect and vertical and horizontal lines effects may occur, and image display quality may be thereby deteriorated.

### BRIEF SUMMARY OF THE INVENTION

Exemplary embodiments of the invention provide a method of driving a display panel.

Exemplary embodiments of the invention provide a method of displaying a three dimensional stereoscopic image using the method of driving the display panel.

Exemplary embodiments of the invention provide a display apparatus that operates based on the method of driving the display panel.

According to an exemplary embodiment of the invention, a method of driving a display panel includes: applying a data signal to the display panel during a sub-active interval based on a data enable signal, and blocking the data signal applied to the display panel during the sub-blanking interval. In such an embodiment, the data enable signal is activated during the sub-active interval and deactivated during the sub-blanking interval, a frame is divided into a plurality of sub-frames, and each of the sub-frames is divided into the sub-active interval and the sub-blanking interval.

In an exemplary embodiment, lengths of the sub-frames may be substantially the same as each other.

In an exemplary embodiment, lengths of the sub-active intervals of the sub-frames may be substantially the same as each other.

In an exemplary embodiment, lengths of at least two of the sub-active intervals of the sub-frames may be different from each other.

In an exemplary embodiment, lengths of at least two of the sub-frames may be different from each other.

In an exemplary embodiment, lengths of the sub-active intervals of the sub-frames may be substantially the same as each other.

In an exemplary embodiment, lengths of at least two of the sub-active intervals of the sub-frames may be different from each other.

According to another exemplary embodiment of the invention, a method of displaying a three-dimensional (“3D”) image includes: applying a left-eye data signal or a right-eye data signal to a display panel during a sub-active interval based on a data enable signal, where a frame is divided into a plurality of sub-frames, and each of the sub-frames is divided into the sub-active interval and a sub-blanking interval; and sequentially driving a plurality of light emitting blocks of the display panel on a sub-frame-by-sub-frame basis, wherein the light emitting blocks correspond to a plurality of display blocks of the display panel. In such an embodiment, the data enable signal is activated during the sub-active interval and deactivated during the sub-blanking interval.

In an exemplary embodiment, the method may further include generating a flag signal, where the flag signal is synchronized with the sub-frames and controls a driving period of each of the light emitting blocks; and generating a dimming signal, where the dimming signal is synchronized with the flag signal and controls a brightness level of each of the light emitting blocks on the sub-frame-by-sub-frame basis. In such an embodiment, the dimming signal may include a plurality of block dimming data, the block dimming data of a current sub-frame may correspond to the light emitting blocks of a next sub-frame, and the light emitting blocks may be driven based on the dimming signal.

In an exemplary embodiment, the block dimming data may have a low data and a high data. The low data may turn off the light emitting blocks during the sub-frame. The high data may turn on the light emitting blocks during the sub-frame. Each of the light emitting blocks may selectively emit light during the sub-frame.

In an exemplary embodiment, the block dimming data of the current sub-frame may include at least one of a low data and a high data, the low data turns off the light emitting may block during the next sub-frame, the high data turns on the light emitting may block during the next sub-frame, and each of the light emitting blocks may emit light during the next sub-frame based on a corresponding block dimming data of the block dimming data of the current frame.

In an exemplary embodiment, the block dimming data of the current sub-frame may include at least one of a low data, a high data and a first extension data, the low data may turn off the light emitting may block during the next sub-frame, the high data may turn on the light emitting may block during the next sub-frame, the first extension data may turn on the light emitting may block during a predetermined latter portion of the next sub-frame, and at least one of the light emitting blocks may emit light during an interval greater than a length of the next sub-frame based on the first extension data.

In an exemplary embodiment, the block dimming data of the current sub-frame may include at least one of a low data, a high data and a second extension data, the low data may turn off the light emitting may block during the next sub-frame, the high data may turn on the light emitting may block during the next sub-frame, the second extension data may turn on the light emitting may block during a predetermined early portion of the next sub-frame, and at least one of the light emitting blocks may emit light during an interval greater than a length of the next sub-frame based on the second extension data.

In an exemplary embodiment, lengths of the sub-frames may be substantially the same as each other.

According to another exemplary embodiment of the invention, a display apparatus includes: a display panel; a data driving part which outputs a data signal to the display panel; a timing controller which outputs a data signal to the data driving part during a sub-active interval based on a data enable signal, where the data enable signal is activated during the sub-active interval and deactivated during a sub-blanking interval, a frame is divided into a plurality of sub-frames, and each of the sub-frames is divided into the sub-active interval and the sub-blanking interval; and a light source part including a plurality of light emitting blocks, where the light source part sequentially supplies light to a plurality of light emitting blocks of the display panel on a sub-frame-by-sub-frame basis.

In an exemplary embodiment, the timing controller may generate a flag signal and a dimming signal, and the flag signal may be synchronized with the sub-frame and control a driving period of each of the light emitting blocks. In such an embodiment, the dimming signal may be synchronized with the flag signal and control a brightness level of each of the light emitting blocks by every sub-frame, and the dimming signal may include a plurality of block dimming data, where the block dimming data of a current sub-frame may correspond to the light emitting blocks of a next sub-frame.

In an exemplary embodiment, the display apparatus may include a light source driving part which drives the light emitting blocks, where the light source driving part may determine a pulse width of each of light source signals based on the dimming signal.

In an exemplary embodiment, the block dimming data of the current sub-frame may include at least one of a low data and a high data, the low data may turn off the light emitting may block during the next sub-frame, the high data may turn on the light emitting may block during the next sub-frame, and the light source driving part may generate the light source driving signals having a pulse width substantially the same as a length of the sub-frames.

In an exemplary embodiment, the block dimming data may further include at least one of a first extension data and a second extension data, the first extension data may turn on the light emitting may block during a predetermined latter portion of the next sub-frame, the second extension data may turn on the light emitting may block during a predetermined early portion of the next sub-frame, and the light source driving part may generate the light source driving signal having a pulse width greater than the length of the sub-frames based on at least one of the first and second extension data.

In an exemplary embodiment, the number of the sub-frames may correspond to the number of the light emitting blocks, and lengths of the sub-frames may be substantially the same as each other.

According to the exemplary embodiments of the invention, the display panel may be driven based on a data enable signal having converted horizontal and vertical blanking intervals, and light is sequentially supplied to each of a plurality of display blocks, on which a 3D image is displayed. The 3D image is displayed on the display blocks based on the data enable signal having substantially consistent periods such that image display quality of the 3D images is substantially improved. In an exemplary embodiment, the light source driving signal may have various pulse widths.

### BRIEF DESCRIPTION OF THE DRAWINGS

The above and other features of the invention will become more apparent by describing in detail exemplary embodiments thereof with reference to the accompanying drawings, in which:

FIG. 1 is a block diagram illustrating an exemplary embodiment of a display apparatus according to the invention;

FIG. 2 is a signal timing diagram of an exemplary embodiment of driving signals of the display apparatus of FIG. 1;

FIGS. 3A to 3C are waveform diagrams showing data enable signals of exemplary embodiments of the display apparatus according to the invention;

FIG. 4 is a block diagram illustrating an alternative exemplary embodiment of a display apparatus according to the invention;

FIG. 5 is a signal timing diagram of driving signals of the display apparatus of FIG. 4, driven in a two-dimensional (“2D”) mode;

FIG. 6 is a signal timing diagram of driving signals of the display apparatus of FIG. 4, driven in a three-dimensional (“3D”) mode;

FIG. 7 is a signal timing diagram of an exemplary embodiment of driving signals of a light source part of the display apparatus according to the invention;

FIG. 8 is a signal timing diagrams of an alternative exemplary embodiment of driving signals of the light source part according to the invention; and

FIG. 9 is a signal timing diagram of another alternative exemplary embodiment of driving signals of the light source part according to the invention.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiment of the invention will be described in detail with reference to the accompanying drawings.

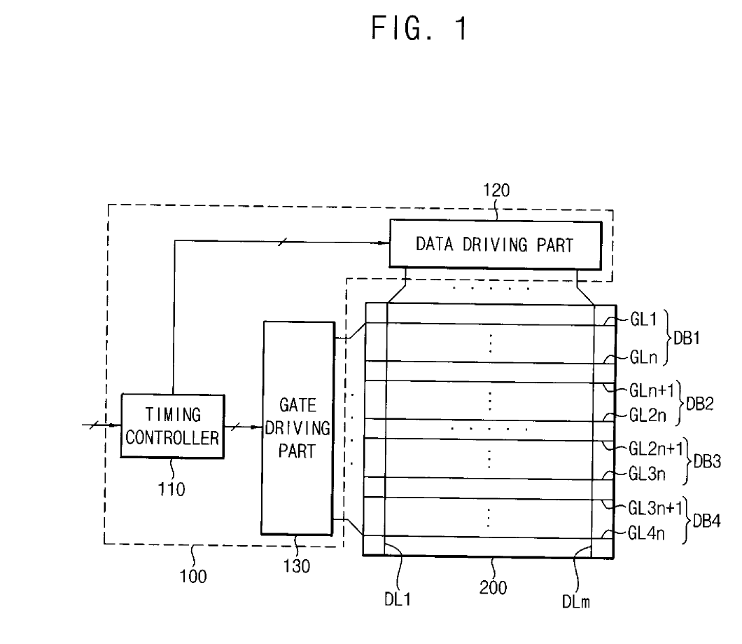

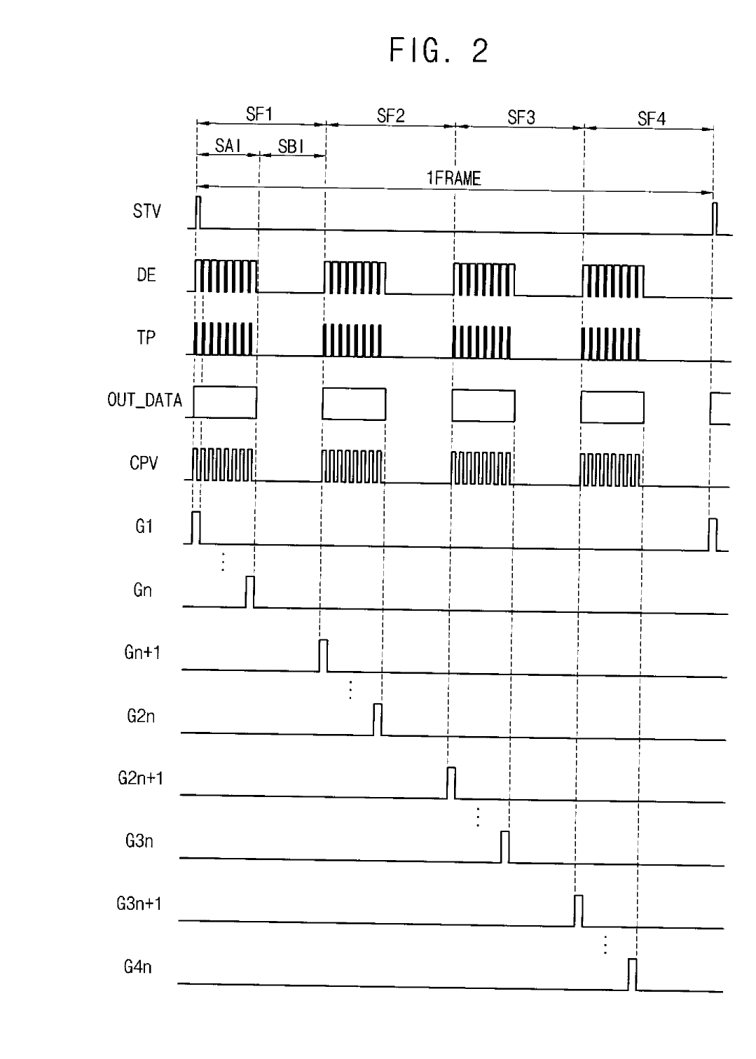

FIG. 1 is a block diagram illustrating an exemplary embodiment of a display apparatus according to the invention. FIG. 2 is a signal timing diagram of an exemplary embodiment of driving signals of the display apparatus of FIG. 1.

Referring to FIGS. 1 and 2, the display apparatus include a panel driving part 100 and a display panel 200. The panel driving part 100 include a timing controller 110, a data driving part 120 and a gate driving part 130.

The display panel 200 include a plurality of data lines, e.g., first to m-th data lines DL1 to DLm (m is a natural number), and a plurality of gate lines, e.g., first to 4n-th gate lines GL1 to GL4n (n is a natural number). In an exemplary embodiment, the display panel 200 may include a plurality of pixels (not shown). Each of the pixels may include a switching element (not shown) connected to a corresponding data line of the data lines DL1 to DLm and a corresponding gate line of the gate lines GL1 to GL4n, and a liquid crystal capacitor (not shown) connected to the switching element (not shown).

The timing controller 110 receives an image data. The timing controller 110 generates a data controlling signal and a gate controlling signal. The data controlling signal controls the data driving part 120 based on a vertical starting signal STV and a data enable signal DE. The gate controlling signal controls the gate driving part 130 based on the vertical starting signal STV and the data enable signal DE. The vertical starting signal STV is for identifying a frame. In an exemplary embodiment, as shown in FIG. 2, the vertical signal STV includes a pulse each starting time of the frame. The data enable signal DE is for processing the image data. In an exemplary embodiment, the vertical starting signal STV and the data enable signal DE may be received from an external device (not shown).

The data controlling signal may include a load signal TP. The gate controlling signal may include a pulse controlling signal CPV. The timing controller 110 applies the image date to the data driving part 120 based on the data enable signal DE.

In an exemplary embodiment, the data enable signal DE may have a plurality of sub-frames in a frame. Each of the sub-frames may have a sub-active interval SAI and a sub-blanking interval SBI.

In an exemplary embodiment, as shown in FIG. 2, the data enable signal DE has a first sub-frame SF1, a second sub-frame SF2, a third sub-frame SF3 and a fourth sub-frame SF4 in a unit frame 1FRAME. Each of the sub-frames has the sub-active interval SAI and the sub-blanking interval SBI.

The sub-active interval SAI has a plurality of horizontal intervals. In an exemplary embodiment, a horizontal line is driven during each of the horizontal intervals. In such an embodiment, a plurality of horizontal lines is driven during the sub-active interval SAI.

In an exemplary embodiment, first to n-th horizontal lines may correspond to the first to n-th gate lines GL1 to GLn, and be driven during the sub-active interval SAI of the first sub-frame SF1. In such an embodiment, (n+1)-th to 2n-th horizontal lines may correspond to the (n+1)-th to 2n-th gate lines GLn+1 to GL2n, and be driven during the sub-active interval SAI of the second sub-frame SF2. In such an embodiment, (2n+1)-th to 3n-th horizontal lines may correspond to the (2n+1)-th to 3n-th gate lines GL2n+1 to GL3n, and be driven during the sub-active interval SAI of the third sub-frame SF3. In such an embodiment, (3n+1)-th to 4n-th horizontal lines may correspond to the (3n+1)-th to 4n-th gate lines GL3n+1 to GL4n, and be driven during the sub-active interval SAI of the fourth sub-frame SF4.

The data driving part 120 outputs a data signal to the display panel 200 on a horizontal-line-by-horizontal-line basis, e.g., in the unit of horizontal line, based on the image data received from the timing controller 110 and the data controlling signal received from the timing controller 110. In one exemplary embodiment, for example, the data driving part 120 receives the image data form the timing controller 110 based on the data enable signal DE. In an exemplary embodiment, the data driving part 120 converts the image data into the data signals of an analog type in response to the load signal TP, and outputs the data signals, which has data sequences corresponding to the horizontal lines, to the data lines DL1 to DLm of the display panel 200.

The gate driving part 130 generates a plurality of gate signals based on the pulse controlling signal CPV received from the timing controller 110. The gate driving part 130 sequentially outputs the gate signals to the gate lines GL1 to GL4n of the display panel 200. In an exemplary embodiment, the display panel 200 may be divided into four display block, e.g., a first display block DB1, a second display block DB2, a third display block DB3 and a fourth display block DB4. In such an embodiment, the first display block DB1 corresponds to the first to n-th gate lines GL1 to GLn, the second display block DB2 corresponds to the (n+1)-th to 2n-th gate lines GLn+1 to GL2n, the third display block DB3 corresponds to the 3n-th gate lines GL2n+1 to GL3n, and the fourth display block DB4 corresponds to the (3n+1)-th to 4n-th gate lines GL3n+1 to GL4n.

In an exemplary embodiment, the gate signals of the first to n-th gate lines GL1 to GLn and the data signals of the first to the n-th horizontal lines are transmitted to the first display block DB1 during the sub-active interval SAI of the first sub-frame SF1. In such an embodiment, the data signals of the first to n-th horizontal lines are not transmitted, e.g., blocked from being transmitted, to the first display block DB1 during the sub-blanking interval SBI of the first sub-frame SF1. In an exemplary embodiment, the gate signals of the (n+1)-th to 2n-th gate lines GLn+1 to GL2n and the data signal of the (n+1)-th to 2n-th horizontal lines are transmitted to the second display block DB2 during the sub-active interval SAI of the second sub-frame SF2. In an embodiment, the data signals of the (n+1)-th to 2n-th horizontal lines are not transmitted e.g., blocked from being transmitted, to the second display block DB2 during the sub-blanking interval SBI of the second sub-frame SF2. In an exemplary embodiment, the gate signals of the (2n+1)-th to 3n-th gate lines GL2n+1 to GL3n and the data signal of the (2n+1)-th to 3n-th horizontal lines are transmitted to the third display block DB3 during the sub-active interval SAI of the third sub-frame SF3. In such an embodiment, the data signals of the (2n+1)-th to 3n-th horizontal lines are not transmitted, e.g., blocked from being transmitted, to the third display block DB3 during the sub-blanking interval SBI of the third sub-frame SF3. In, the gate signals of the (3n+1)-th to 4n-th gate lines GL3n+1 to GL4n and the data signal of the (3n+1)-th to 4n-th horizontal lines are transmitted to the fourth display block DB4 during the sub-active interval SAI of the fourth sub-frame SF4. In such an embodiment, the data signals of the (3n+1)-th to 4n-th horizontal lines are not transmitted, e.g., blocked from being transmitted, to the fourth display block DB4 during the sub-blanking interval SBI of the fourth sub-frame SF4. In an exemplary embodiment, the display panel 200 is driven for one frame including the first to fourth sub frames SF1 to SF2.

In an exemplary embodiment, the display panel 200 may be driven based on the data enable signal DE, which is transformed.

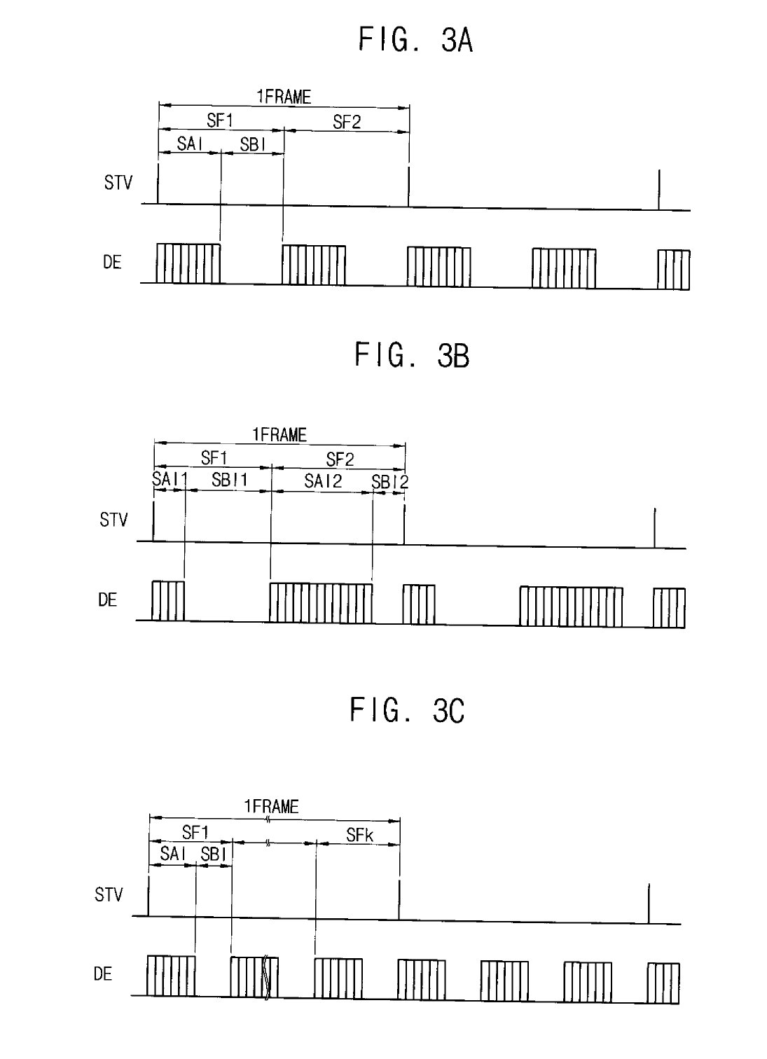

FIGS. 3A to 3C are waveform diagrams showing data enable signals of exemplary embodiments of the display apparatus according to the invention.

Referring to FIGS. 1 to 3A, the data enable signal DE of an exemplary embodiment of a display apparatus is divided into the first sub-frame SF1 and the second sub-frame SF2 in a unit frame 1FRAME. Each of the sub-frames includes the sub-active interval SAI and the sub-blanking interval SBI. In such an embodiment, an upper portion, e.g., an upper half portion, of the display panel 200 is driven during the sub-active interval SAI of the first sub-frame SF1, and a lower portion, e.g., a lower half portion, of the display panel 200 is driven during the sub-active interval SAI of the second sub-frame SF2.

Referring to FIGS. 1 and 3B, the data enable signal DE of an alternative exemplary embodiment of the display apparatus is divided into the first sub-frame SF1 and the second sub-frame SF2 in a unit frame 1FRAME. In an exemplary embodiment, a length of the first sub-frame SF1, which is a time duration of the first sub-frame SF1, may be different from a length of the second sub-frame SF2, which is a time duration of the second sub-frame SF2. The first sub-frame SF1 includes a first sub-active interval SAI1 and a first sub-blanking interval SBI1. The second sub-frame SF2 includes a second sub-active interval SAI2 and a second sub-blanking interval SBI2. In an exemplary embodiment, a length of the first sub-active interval SAI1 may be substantially the same as a length of the second sub-active interval SAI2. In an alternative exemplary embodiment, the length of the first sub-active interval SAI1 may be different from the length of the second sub-active interval SAI2. In an exemplary embodiment, a length of the first sub-blanking interval SBI1 may be substantially the same as a length of the second sub-blanking interval SBI2. In an alternative exemplary embodiment, the length of the first sub-blanking interval SBI1 may be different from the length of the second sub-blanking interval SBI2.

In an exemplary embodiment, as described in FIGS. 1 and 3B, the length of the first sub-active interval SAI1 may be shorter than the length of the second sub-active interval SAI2. In an alternative exemplary embodiment, the length of the first sub-active interval SAI1 may be longer than the length of the second sub-active interval SAI2. In another alternative exemplary embodiment, the length of the first sub-active interval SAI1 may be substantially the same as the length of the second sub-active interval SAI2.

In an exemplary embodiment, as shown in FIGS. 1 and 3B, the length of first sub-blanking interval SBI1 may be longer than the length of the second sub-blanking interval SBI2. In an alternative exemplary embodiment, the length of the first sub-blanking interval SBI1 may be substantially the same as the length of the second sub-blanking interval SBI2.

Referring to FIG. 3C, the data enable signal DE of an exemplary embodiment of the display apparatus may be divided into a plurality of sub-frames, e.g., a first sub-frame SF1 to a k-th sub-frame SFk, in a unit frame 1FRAME. In an exemplary embodiment, the first sub-frame SF1 to k-th sub-frame SFk may have lengths substantially the same as each other. In an alternative exemplary embodiment, a length of at least one of the first to k-th sub-frames SF1 to SFk may be different from lengths of remaining sub-frames. Each of sub-frames includes the sub-active interval SAI and the sub-blanking interval SBI. In an exemplary embodiment, the sub-active intervals of the first sub-frame SF1 to k-th sub-frame SFk may have lengths substantially the same as each other. In an alternative exemplary embodiment, a length of at least one of the sub-active intervals of the first sub-frame SF1 to k-th sub-frame SFk may be different from lengths of remaining sub-frames. In an exemplary embodiment, the sub-blanking intervals of the first sub-frame SF1 to k-th sub-frame SFk may have lengths substantially the same as each other. In an alternative exemplary embodiment, a length of at least one of the sub-blanking intervals of the first sub-frame SF1 to k-th sub-frame SFk may be different from lengths of remaining sub-frames. The length of the sub-blanking interval may be controlled on-a-horizontal-line-by-horizontal-line basis.

The data enable signal DE is not limited to the embodiment described above, and may be variously configured.

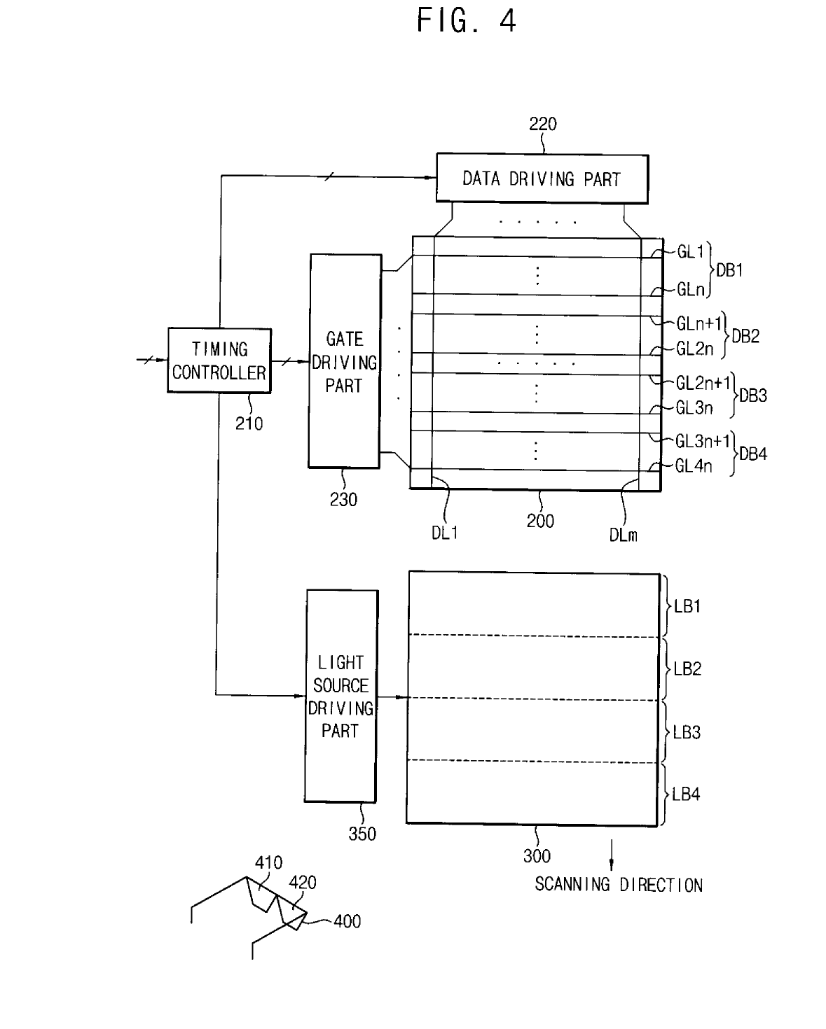

FIG. 4 is a block diagram illustrating an alternative exemplary embodiment of a display apparatus according to the invention.

The same or like elements shown in FIG. 4 have been labeled with the same reference characters as used above to describe the exemplary embodiment of the m-th display apparatus in FIG. 1, and any repetitive detailed description thereof will hereinafter be omitted or simplified.

Referring to FIG. 4, the display apparatus includes a display panel 200, a timing controller 210, a data driving part 220, a gate driving part 230, a light source part 300, a light source driving part 350 and an eyeglasses part 400.

The display panel 200 includes a plurality of data lines, e.g., the first to m-th data lines DL1 to DLm, (m is a natural number), and a plurality of gate lines, e.g., the first to 4n-th gate lines GL1 to GL4n, (n is a natural number). In an exemplary embodiment, the display panel 200 may include a plurality of pixels. Each of the pixels may include a switching element connected to a corresponding data line and a corresponding gate line, and a liquid crystal capacitor connected to the switching element.

In an exemplary embodiment, the timing controller 210 receives a two-dimensional (“2D”) image in a 2D mode, and receives a three-dimensional (“3D”) image in a 3D mode. In such an embodiment, the 3D image may include a left-eye data and a right-eye data.

In an exemplary embodiment, the timing controller 210 generates a 2D data controlling signal (for example, a load signal TP) and a 2D gate controlling signal (for example, a pulse controlling signal CPV) based on a 2D vertical starting signal STV_{—}2D and a 2D data enable signal DE_{—}2D in the 2D mode. The timing controller 210 controls the data driving part 220 and the gate driving part 230 to display a 2D image on the display panel 200. In an exemplary embodiment, the timing controller 210 generates a 3D data controlling signal (for example, a load signal TP) and a 3D gate controlling signal (for example, a pulse controlling signal CPV) based on a 3D vertical starting signal and a 3D data enable signal in the 3D mode. The timing controller 210 controls the data driving part 220 and the gate driving part 230 to display a 3D image on the display panel 200.

The data driving part 220 transforms the image data to the data signal, which is an analog type signal, in response to the image data and the data controlling signal received from the timing controller 210. The data driving part 220 outputs the data signals, which have data sequences corresponding to the horizontal lines, to the data lines DL1 to DLm of the display panel 200.

The gate driving part 230 generates a plurality of gate signals based on the gate controlling signal received from the timing controller 210. The gate driving part 230 sequentially outputs the gate signals to the gate lines GL1 to GL4n of the display panel 200.

The light source part 300 generates and supply light to the display panel 200. In an exemplary embodiment, the light source part 300 includes a plurality of light emitting blocks arranged along a scanning direction. In an exemplary embodiment, the light emitting blocks emit the light at the same time in the 2D mode, and the light emitting blocks sequentially emits the light along the scanning direction in the 3D mode. Hereinafter, for convenience of description, an exemplary embodiment, in which the light source part 300 is divided into first, second, third and fourth light emitting blocks LB1, LB2, LB3 and LB4, will now be described.

The light source driving part 350 generates a light source driving signal to drive the light source part 300 based on a control of the timing controller 210. In an exemplary embodiment, the light source driving part 350 drives all of the light emitting blocks of the light source part 300 to emit the light in the 2D mode during a frame, and the light source driving part 350 drives the light emitting blocks of the light source part 300 to sequentially emit the light in the 3D mode during a frame.

The eyeglasses part 400 includes a left-eye shutter 410 and a right-eye shutter 420. The eyeglasses part 400 selectively opens and closes the left-eye and right-eye shutters 410 and 420 based on a control of the timing controller 210 in the 3D mode. In an exemplary embodiment, the eyeglasses part 400 opens the left-eye shutter 410 and closes the right-eye shutter 420, based on a driving time of the display panel 200 and the light source part 300, during a left image period, during which a left eye image is displayed on the display panel 200. In such an embodiment, the eyeglasses part 400 opens the right-eye shutter 420 and closes the left-eye shutter 410, based on the driving time of the display panel 200 and the light source part 300, during a right eye period, during which a right eye image is displayed on the display panel 200.

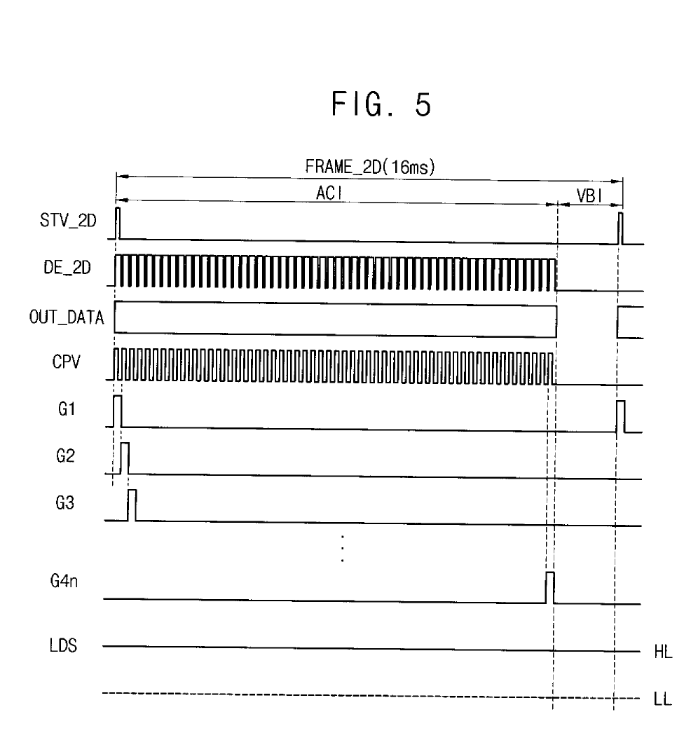

FIG. 5 is a signal timing diagram of driving signals of the display apparatus of FIG. 4 driven in the 2D mode.

Referring to FIGS. 4 and 5, the timing controller 210 generates the 2D data controlling signal (for example, the load signal TP) and the 2D gate controlling signal (for example, the pulse controlling signal CPV) based on the 2D vertical starting signal STV 2D and the 2D data enable signal DE_{—}2D in the 2D mode.

The 2D vertical starting signal defines a 2D frame FRAME_{—}2D based on a first driving frequency. In one exemplary embodiment, for example, a length or a time duration of the 2D frame FRAME_{—}2D may be about 16 milliseconds (ms). The 2D data enable signal DE_{—}2D divides the 2D frame FRAME_{—}2D into an active interval ACI and a vertical blanking interval VBI.

The 2D data enable signal DE_{—}2D is activated during the active interval ACI, and deactivated during the vertical blanking interval VBI. The load signal TP and the pulse controlling signal CPV are synchronized with the 2D data enable signal DE_{—}2D, such that the load signal TP and the pulse controlling signal CPV are activated during the active interval ACI.

The data driving part 220 transforms the image data to the data signal, which is an analog type signal, in response to the image data and the data controlling signal received from the timing controller 210. The data driving part 220 outputs the data signals OUT_DATA, which have data sequences corresponding to the horizontal lines, to the data lines DL1 to DLm of the display panel 200.

The gate driving part 230 generates a plurality of gate signals G1 to G4n based on the gate controlling signal received from the timing controller 210. The gate driving part 230 sequentially outputs the gate signals G1 to G4n to the gate lines GL1 to GL4n of the display panel 200.

The light source driving part 350 generates a light source driving signal LDS based on a control of the timing controller 210. In an exemplary embodiment, the light source driving signal LDS may have a high level HL to drive the light source part 300 in the 2D mode such that all of the first, second, third and fourth light emitting block LB1, LB2, LB3 and LB4 of the light source part 300 emit light when the data signal is outputted to the display panel 200 in the 2D mode.

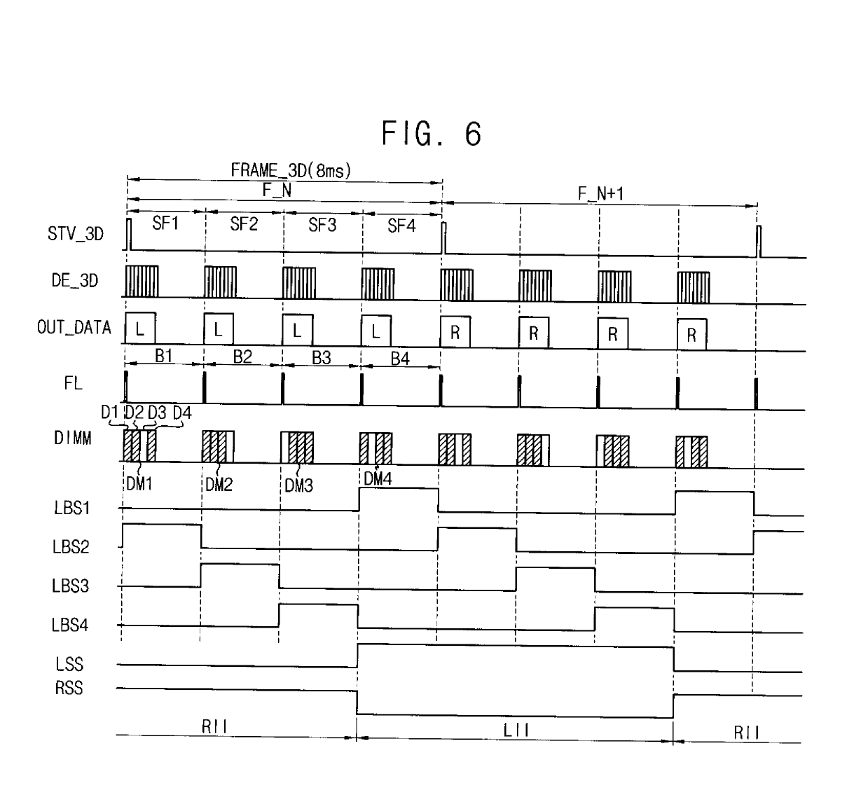

FIG. 6 is a signal timing diagram of driving signals of the display apparatus of FIG. 4 driven in a 3D mode.

Referring to FIGS. 4 and 6, the timing controller 210 generates the 3D data controlling signal and the 3D gate controlling signal based on the 3D vertical starting signal STV_{—}3D and the 3D data enable signal DE_{—}3D in the 3D mode. The 3D data controlling signal may include the load signal TP and the pulse controlling signal CPV, shown in FIG. 2. The load signal TP and the pulse controlling signal CPV are generated based on the 3D data enable signal DE_{—}3D, as shown in FIG. 2.

The 3D vertical starting signal STV_{—}3D defines a 3D frame FRAME_{—}3D based on a second driving frequency. In an exemplary embodiment, the second driving frequency is greater than the first driving frequency the 2D vertical starting signal STV_{—}2D. In one exemplary embodiment, for example, a length or a time duration of the 3D frame FRAME_{—}3D is about 8 ms. The 3D data enable signal DE_{—}3D divides the 3D frame FRAME_{—}3D into a plurality of sub-frames. The number of the sub-frames in the 3D frame FRAME_{—}3D may correspond to the number of the light emitting blocks of the light source part 300.

In an exemplary embodiment, where the light source part 300 includes the first, second, third and forth light emitting blocks LB1, LB2, LB3 and LB4, the 3D data enable signal DE_{—}3D is divided into a first sub-frame SF1, a second sub-frame SF2, a third sub-frame SF3 and a fourth sub-frame SF4 in the 3D frame FRAME_{—}3D. Lengths of the first to fourth sub-frames SF1 to SF4 are substantially the same as each other. Each of the sub-frames includes a sub-active interval and a sub-blanking interval. The 3D data enable signal DE_{—}3D is activated during the sub-active interval, and deactivated during the sub-blanking interval.

In an exemplary embodiment, lengths of the sub-active intervals may be substantially the same as each other. In an exemplary embodiment, lengths of the sub-blanking intervals may be substantially the same as each other.

The data driving part 220 outputs a left-eye data signal L of output data OUT_DATA to the display panel 200 during an N-th frame F_N based on the 3D data enable signal DE_{—}3D. In an exemplary embodiment, the data driving part 220 outputs the left-eye data signal L corresponding to the first display block DB1 during the first sub-frame SF1 of the N-th frame F_N. The data driving part 220 outputs the left-eye data signal L corresponding to the second display block DB2 during the second sub-frame SF2 of the N-th frame F_N. The data driving part 220 outputs the left-eye data signal L corresponding to the third display block DB3 during the third sub-frame SF3 of the N-th frame F_N. The data driving part 220 outputs the left-eye data signal L corresponding to the fourth display block DB4 during the fourth sub-frame SF4 of the N-th frame F_N. In an exemplary embodiment, the data driving part 220 outputs a right-eye data signal R of the output data OUT_DATA to the display panel 200 based on the 3D data enable signal DE_{—}3D during the (N+1)-th frame F_N+1, in a manner described above with respect to the left eye data signal L.

In an exemplary embodiment, the gate driving part 230 applies a gate signal to the display panel based on the 3D data enable signal DE_{—}3D, as shown in FIG. 2. The gate signals are synchronized with output timings of the data driving part 220.

In an exemplary embodiment, the timing controller 210 generates a flag signal FL and a dimming signal DIMM to drive the light source part 300 based on the 3D data enable signal DE_{—}3D. The timing controller 210 applies the flag signal FL and the dimming signal DIMM to the light source driving part 350. In such an embodiment, the light source driving part 350 generates first, second, third and fourth light source driving signals LBS1, LBS2, LBS3 and LBS4 based on the dimming signal DIMM.

The flag signal FL controls the first to forth light emitting block LB1, LB2, LB3 and LB4. In an exemplary embodiment, the flag signal FL has a high pulse corresponding to each of the first, second, third and fourth sub-frames SF1, SF2, SF3 and SF4. The first to forth light emitting block LB1, LB2, LB3 and LB4 may be driven independently of each other in first to fourth driving periods B1, B2, B3 and B4 based on the flag signal FL during the 3D frame FRAME_{—}3D.

In an exemplary embodiment, the sub-frame corresponds to a driving period of the light emitting blocks, as shown in FIG. 6, but not being limited thereto. In an alternative exemplary embodiment, the driving period of the light emitting blocks may not corresponding to the sub-frame, e.g., there may be a delay between the driving period of the light emitting blocks and the sub-frame. In an exemplary embodiment, the delay between the driving period of the light emitting blocks and the sub-frame may be shorter than a length of the sub-frame.

The dimming signal DIMM is synchronized with the flag signal FL to control brightness levels of the first to forth light emitting block LB1, LB2, LB3 and LB4 for each of sub-frames. In an exemplary embodiment, the dimming signal DIMM includes four dimming data in a frame, e.g., a first dimming data DM1, a second dimming data DM2, a third dimming data and a fourth dimming data DM4, respectively corresponding to the four sub-frame of the frame. Each of the dimming data includes a first block dimming data D1, a second block dimming data D2, a third block dimming data D3 and a fourth block dimming data D4, and each of the block dimming data in a current sub-frame is corresponding to operation of the first to forth light emitting block LB1, LB2, LB3 and LB4 of a next sub-frame.

The light source driving part 350 controls first to fourth light source driving signals LBS1, LBS2, LBS3 and LBS4 of the next sub-frame based on the dimming data received during the current sub-frame. In an exemplary embodiment, the light source driving part 350 controls the first to fourth light source driving signals LBS1, LBS2, LBS3 and LBS4 corresponding to the second sub-frame SF2 based on the first dimming data DM1 received during the first sub-frame. In an exemplary embodiment, when a block dimming data of the light source driving signal has the high level, the light emitting block corresponding to the block dimming data is turned-on. When the block dimming data of the light source driving signal has a low level, the light emitting block corresponding to the block dimming data is turned-off.

In an exemplary embodiment, as described in FIG. 6, when the first, second and fourth block dimming data D1, D2 and D4 have the low data and the third block dimming data D3 have the high data, the light source driving part 350 generates the first, second and fourth light source driving signals LBS1, LBS2 and LBS4 having the low level during the second sub-frame SF2 and generates the third light source driving signal LBS3 having the high level during the second sub-frame SF2.

In an exemplary embodiment, the light source driving part 350 generates the first to fourth light source driving signals LBS1, LBS2, LBS3 and LBS4 based on the flag signal FL and the dimming signal DIMM. In an exemplary embodiment, the dimming signal DIMM controls a pulse width of each of the first to fourth light source driving signals LBS1, LBS2, LBS3 and LBS4 to be substantially the same as the driving period.

In an exemplary embodiment, the first light emitting block LB1 generates light during the fourth sub-frame SF4, during which the left or right eye image is displayed on the first display block DB1 of the display panel 200. The second light emitting block LB2 generates light during the first sub-frame SF1, during which the left or right eye image is displayed on the second display block DB2 of the display panel 200. The third light emitting block LB3 generates light during the second sub-frame SF2, during which the left or right eye image is displayed on the third display block DB3 of the display panel 200. The fourth light emitting block LB4 generates light during the third sub-frame SF3, during which the left or right eye image is displayed on the fourth display block DB4 of the display panel 200.

The timing controller 210 applies a left-eye shutter signal LSS and a right-eye shutter signal RSS to drive the left-eye shutter 410 and the right-eye shutter 420.

The left-eye shutter signal LSS has the high level during a left-eye image displaying interval LII. The first to forth light emitting block LB1, LB2, LB3 and LB4 supply light to the display panel 200 to display the left-eye image during the left-eye image displaying interval LII. The left-eye shutter signal LSS has the low level during a right-eye image displaying interval RHI.

The right-eye shutter signal RSS has the high level during a right-eye image displaying interval RII. The first to forth light emitting block LB1, LB2, LB3 and LB4 supply light to the display panel 200 to display the right-eye image during the right-eye image displaying interval RII. The right-eye shutter signal RSS has the low level during a left-eye image displaying interval LII. However, lengths and arrangements of the left-eye and the right-eye image displaying intervals LII and RII are not limited to the exemplary embodiment shown in FIG. 6. In alternative exemplary embodiments, the left-eye and the right-eye image displaying intervals LII and RII may have various positions and length.

The eyeglasses part 400 opens the left-eye shutter 410 and closes the right-eye shutter 420 based on the left and right-eye shutter signal LSS and RSS during the left-eye image displaying interval LII. The eyeglasses part 400 opens the right-eye shutter 420 and closes the left-eye shutter 410 based on the left and right-eye shutter signal LSS and RSS during the right-eye image displaying interval RII.

In an exemplary embodiment, the light emitting blocks are driven based on the data enable signal DE_{—}3D, such that the driving periods of the light emitting blocks are substantially the same as each other. In such an embodiment, the light emitting blocks emit light during a same liquid crystal reaction time for each of the displaying blocks, such that a brightness difference between the display blocks is substantially reduced, and display quality of the 3D images is thereby substantially improved.

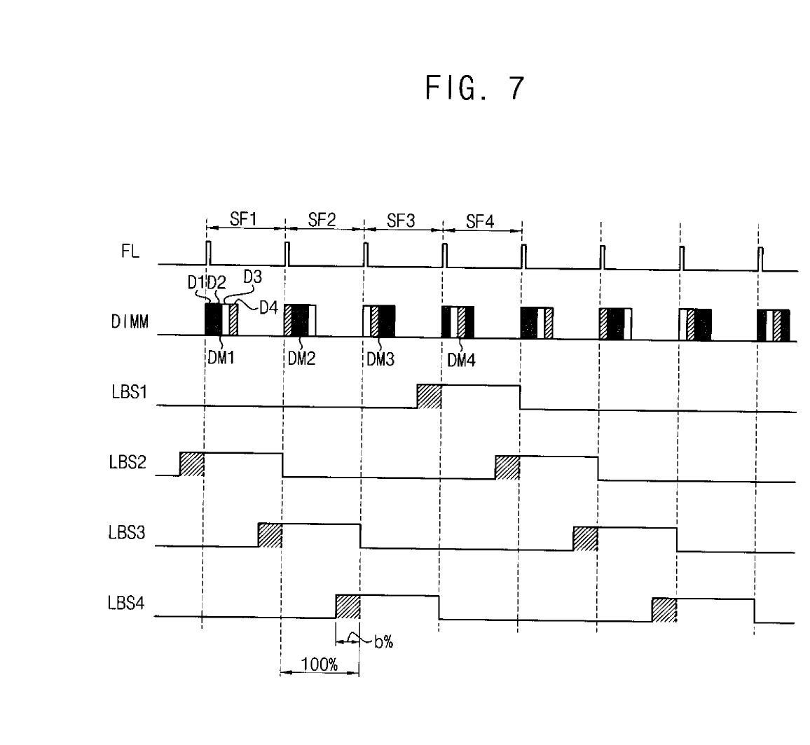

FIG. 7 is a signal timing diagram of an exemplary embodiment of driving signals of a light source part of the display apparatus according to the invention.

The same or like elements shown in FIG. 7 have been labeled with the same reference characters as used above to describe the exemplary embodiment of the driving signals in FIG. 6, and any repetitive detailed description thereof will hereinafter be omitted or simplified.

Referring to FIGS. 4 and 7, the timing controller 210 applies a flag signal FL and a dimming signal DIMM to the light source driving part 350, which controls the light source part 300 based on the flag signal FL and the dimming signal DIMM.

In an exemplary embodiment, the dimming signal DIMM may control a pulse width of each of the first to fourth light source driving signals LBS1, LBS2, LBS3 and LBS4.

In an exemplary embodiment, the dimming signal DIMM is synchronized with the flag signal FL. The dimming signal DIMM includes four dimming data in the 3D frame FRAME_{—}3D frame, e.g., a first dimming data DM1, a second dimming data DM2, a third dimming data and a fourth dimming data DM4, respectively corresponding to the four sub-frame of the 3D frame FRAME_{—}3D. In an exemplary embodiment, each of the dimming data of a current sub-frame includes a first block dimming data D1, a second block dimming data D2, a third block dimming data D3 and a fourth block dimming data D4, respectively corresponding to the first to forth light emitting block LB1, LB2, LB3 and LB4 of a next sub-frame.

The light source driving part 350 controls first to fourth light source driving signals LBS1, LBS2, LBS3 and LBS4 corresponding to the next sub-frame based on the dimming data received during the current sub-frame.

In an exemplary embodiment, the light source driving part 350 controls levels of the first to fourth light source driving signals LBS1, LBS2, LBS3 and LBS4 corresponding to the second sub-frame SF2 based on the first dimming data DM1 received during the first sub-frame.

In an exemplary embodiment, as shown in FIG. 7, the first and second block dimming data D1 and D2 of the first dimming data DM1 may have the low data, the fourth block dimming data D4 of the first dimming data DM1 may have the high data, and the third block dimming data D3 of the first dimming data DM1 may have a first extension data b. In such an embodiment, the light source driving part 350 generates the first and second light source driving signals LBS1 and LBS2 having the low level during the second sub-frame SF2, and generates the third light source driving signal LBS3 having the high level based on the third block dimming data D3 during the second sub-frame SF2.

In such an embodiment, when an entire length of the second sub-frame SF2 is defined as 100 percent (%) of the second sub-frame SF2, the light source driving part 350 generates the fourth light source driving signals LBS4 having the high level during latter b % of the second sub-frame SF2 based on the fourth block dimming data D4 of the first dimming data DM1. In one exemplary embodiment, for example, the value of b is 30, and the light source driving part 350 generates the fourth light source driving signals LBS4 having the high level during latter 30% of the second sub-frame SF2.

In an exemplary embodiment, the light source driving part 350 controls levels of the first to fourth light source driving signals LBS1, LBS2, LBS3 and LBS4 corresponding to the third sub-frame SF3 based on the second dimming data DM2 received during the second sub-frame SF2.

In an exemplary embodiment, as shown in FIG. 7, the first block dimming data D1 of the second dimming data DM2 may have the first extension data b, the second and third block dimming data D2 and D3 of the second dimming data DM2 have the low data, and the fourth block dimming data D4 of the first dimming data DM1 may have the high data. In such an embodiment, the light source driving part 350 generates the first light source driving signal LBS1 having the high level during latter b % of the third sub-frame SF3. The light source driving part 350 generates the second and third light source driving signals LBS2 and LBS3 having the low level based on the second and third block dimming data D2 and D3 during the third sub-frame SF3, and generates the fourth light source driving signals LBS4 having the high level based on the fourth block dimming data D4 during the third sub-frame SF3.

In an exemplary embodiment, as shown in FIG. 7, the fourth light source driving signals LBS4 may extend from the second sub-frame SF2 to the third sub-frame SF3 by b %, such that the fourth light source driving signals LBS4 may have a pulse width greater than a length of the sub-frame.

In an exemplary embodiment, each of the first to fourth light source driving signals LBS1, LBS2, LBS3 and LBS4 may have a same pulse width. In an alternative exemplary embodiment, the first to fourth light source driving signals LBS1, LBS2, LBS3 and LBS4 may have pulse widths different from each other. In an exemplary embodiment, each of the first to fourth light source driving signals LBS1, LBS2, LBS3 and LBS4 may have a selectively extended pulse width based on based on the value of the extension data in the first to fourth dimming data DM1, DM2, DM3 and DM4.

In an exemplary embodiment of a method of driving a display panel, the pulse width of the light source driving signal may be selectively extended based on a local dimming driving, in which brightness level of the light source part 300 is independently driven for each display area based on the brightness level of an image displayed on the display panel 200.

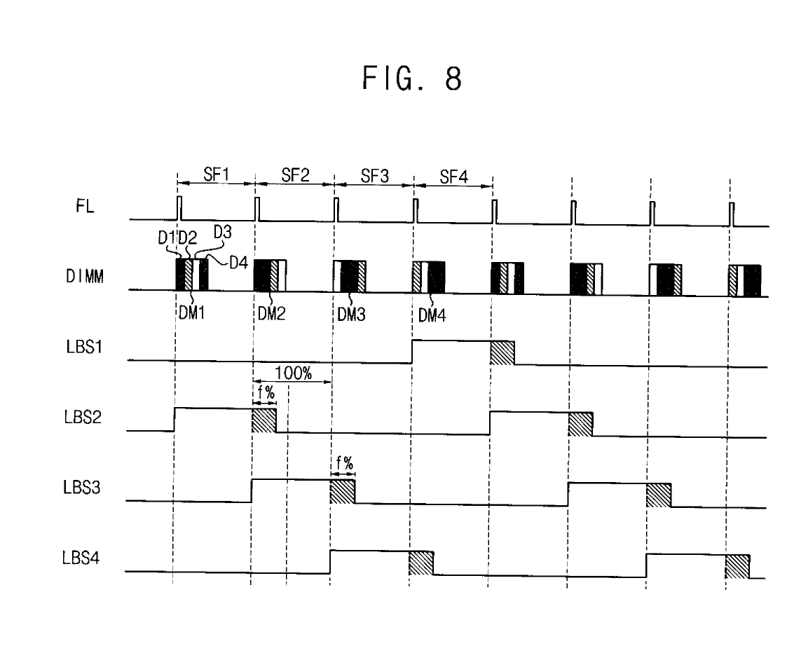

FIG. 8 is a signal timing diagrams of an alternative exemplary embodiment of driving signals of the light source part according to the invention.

The same or like elements shown in FIG. 8 have been labeled with the same reference characters as used above to describe the exemplary embodiment of the driving signals in FIG. 6, and any repetitive detailed description thereof will hereinafter be omitted or simplified.

Referring to FIGS. 4 and 8, a dimming signal DIMM may control a pulse width of each of first to fourth light source driving signals LBS1, LBS2, LBS3 and LBS4.

The light source driving part 350 controls first to fourth light source driving signals LBS1, LBS2, LBS3 and LBS4 corresponding to the next sub-frame based on the dimming data received during the current sub-frame.

In an exemplary embodiment, the light source driving part 350 controls levels of the first to fourth light source driving signals LBS1, LBS2, LBS3 and LBS4 corresponding to the second sub-frame SF2 based on the first dimming data DM1 received during the first sub-frame.

As shown in FIG. 8, the first and fourth block dimming data D1 and D4 of the first dimming data DM1 may have the low data, the third block dimming data D3 of the first dimming data DM1 may have the high data, and the second block dimming data D2 of the first dimming data DM1 may have a second extension data having a value of f. In such an embodiment, the light source driving part 350 generates the first and fourth light source driving signals LBS1 and LBS4 having the low level during the second sub-frame SF2 based on the first and fourth block dimming data D1 and D4, and generates the third light source driving signal LBS3 having the high level based on the third block dimming data D3 during the second sub-frame SF2. In such an embodiment, when an entire length of the second sub-frame SF2 is defined as 100%, the light source driving part 350 generates the second light source driving signals LBS2 having the high level during early f % of the second sub-frame SF2 based on the second block dimming data D2. In one exemplary embodiment, for example, the value of f is 30, the light source driving part 350 generates the second light source driving signals LBS2 having the high level during early 30% of the second sub-frame SF2.

In an exemplary embodiment, the light source driving part 350 controls levels of the first to fourth light source driving signals LBS1, LBS2, LBS3 and LBS4 corresponding to the third sub-frame SF3 based on the second dimming data DM2 received during the second sub-frame SF2.

As shown in FIG. 8, the first and second block dimming data D1 and D2 of the second dimming data DM2 may have the low data, the third block dimming data D3 of the second dimming data DM2 may have the second extension data having the value of f, and the fourth block dimming data D4 of the first dimming data DM1 may have the high data. In such an embodiment, the light source driving part 350 generates the first and second light source driving signal LBS1 and LBS2 having the low level based on the first and second block dimming data D1 and D2 during the third sub-frame SF3, and generates the third light source driving signals LBS3 having the high level based on the third block dimming data D3 during the early f % of the third sub-frame SF3. In such an embodiment, the light source driving part 350 generates the fourth light source driving signals LBS4 having the high level based on the fourth block dimming data D4 during the third sub-frame SF3.

In such an embodiment, the third light source driving signals LBS3 may extend from the third sub-frame SF3 to the third sub-frame SF3 by f %, such that the third light source driving signals LBS3 may have a pulse width greater than the length of the sub-frame.

In an exemplary embodiment, each of the first to fourth light source driving signals LBS1, LBS2, LBS3 and LBS4 may have a same pulse width same. In an alternative exemplary embodiment, the first to fourth light source driving signals LBS1, LBS2, LBS3 and LBS4 may have pulse widths different from each other. In an exemplary embodiment, each of the first to fourth light source driving signals LBS1, LBS2, LBS3 and LBS4 may have a selectively extended pulse width based on the value of the extension data in the first to fourth dimming data DM1, DM2, DM3 and DM4.

In an exemplary embodiment of a method of driving a display panel, the pulse width of the light source driving signal may be selectively extended based on a local dimming driving, in which brightness level of the light source part 300 is independently driven for each display area based on the brightness level of an image displayed on the display panel 200.

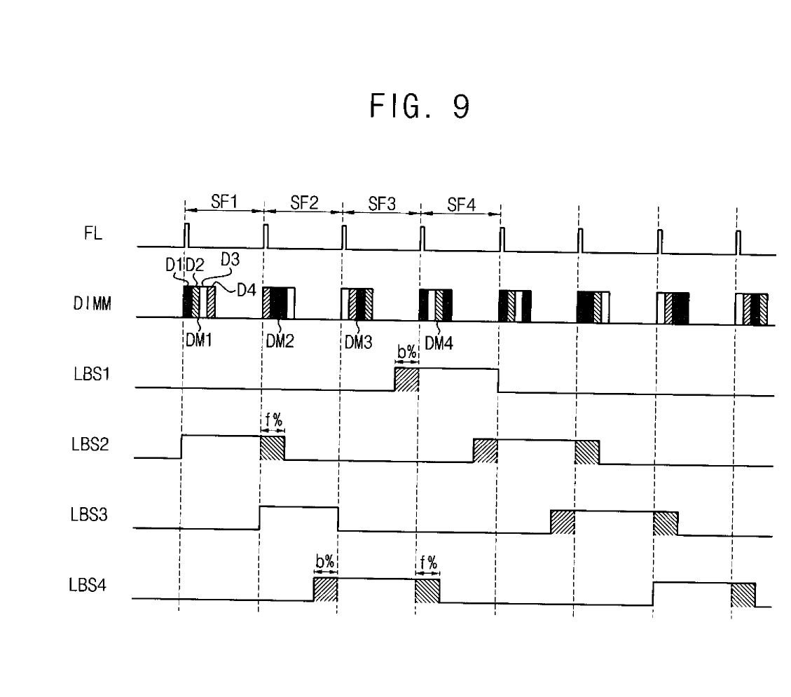

FIG. 9 is a signal timing diagram of another alternative exemplary embodiment of driving signals of the light source part according to the invention.

The same or like elements shown in FIG. 9 have been labeled with the same reference characters as used above to describe the exemplary embodiment of the driving signals in FIG. 6, and any repetitive detailed description thereof will hereinafter be omitted or simplified.

Referring to FIGS. 4 and 9, a dimming signal DIMM may control a pulse width of each of first to fourth light source driving signals LBS1, LBS2, LBS3 and LBS4.

The light source driving part 350 controls first to fourth light source driving signals LBS1, LBS2, LBS3 and LBS4 corresponding to the next sub-frame based on the dimming data received during the current sub-frame.

In an exemplary embodiment, the light source driving part 350 controls levels of the first to fourth light source driving signals LBS1, LBS2, LBS3 and LBS4 corresponding to the second sub-frame SF2 based on the first dimming data DM1 received during the first sub-frame.

As described in FIG. 9, the first block dimming data D1 of the first dimming data DM1 may have the low data, the second block dimming data D2 of the first dimming data DM1 may have second extension data having a value of f, the third block dimming data D3 of the first dimming data DM1 may have the high data, and the fourth block dimming data D4 of the first dimming data DM1 may have first extension data having a value of b. In such an embodiment, the light source driving part 350 generates the first light source driving signal LBS1 having the low level during the second sub-frame SF2 based on the first block dimming data D1, generates the second light source driving signal LBS2 having the high level based on the second block dimming data D2 during the early f % of the second sub-frame SF2, generates the third light source driving signal LBS3 having the high level during the second sub-frame SF2 based on the third block dimming data D3, and generates the fourth light source driving signal LBS4 having the high level based on the fourth block dimming data D4 during the latter b % of the second sub-frame SF2.

In such an embodiment, the light source driving part 350 controls levels of the first to fourth light source driving signals LBS1, LBS2, LBS3 and LBS4 corresponding to the third sub-frame SF3 based on the second dimming data DM2 received during the second sub-frame SF2.

As described in FIG. 9, the first block dimming data D1 of the second dimming data DM2 may have first extension data having a the value of b, the second block dimming data D2 of the second dimming data DM2 may have the low data, the third block dimming data D3 of the first dimming data DM1 may have the low data, and the fourth block dimming data D4 of the first dimming data DM1 may have the high data. In such an embodiment, the light source driving part 350 generates the first light source driving signal LBS1 having the high level based on the first block dimming data D1 during the latter b % of the third sub-frame SF3. The light source driving part 350 generates the second light source driving signal LBS2 having the low level based on the second block dimming data D2 during the third sub-frame SF3. The light source driving part 350 generates the third light source driving signal LBS3 having the low level based on the third block dimming data D3 during the third sub-frame SF3. The light source driving part 350 generates the fourth light source driving signal LBS4 having the high level based on the fourth block dimming data D4 during the third sub-frame SF3.

In an such an embodiment, the light source driving part 350 controls levels of the first to fourth light source driving signals LBS1, LBS2, LBS3 and LBS4 corresponding to the third sub-frame SF3 based on the second dimming data DM2 received during the second sub-frame SF2.

As described in FIG. 9, the first block dimming data D1 of the third dimming data DM3 may have the high data, the second block dimming data D2 of the second dimming data DM2 may have first extension data having the value of b, the third block dimming data D3 of the first dimming data DM1 may have the low data, and the fourth block dimming data D4 of the first dimming data DM1 may have second extension data having a value of f. In such an embodiment, the light source driving part 350 generates the first light source driving signal LBS1 having the high level based on the first block dimming data D1 during the fourth sub-frame SF4. The light source driving part 350 generates the second light source driving signal LBS2 having the high level based on the second block dimming data D2 during the latter b % of the fourth sub-frame SF4. The light source driving part 350 generates the third light source driving signal LBS3 having the low level based on the third block dimming data D3 during the fourth sub-frame SF4. The light source driving part 350 generates the fourth light source driving signal LBS4 having the high level based on the fourth block dimming data D4 during the early f % of the fourth sub-frame SF4.

In an exemplary embodiment, as shown in FIG. 9, the fourth light source driving signals LBS4 may have the high voltage during a period extending from the third sub-frame SF3 to the second sub-frame SF2 by b %, and extending from the third sub-frame SF3 to the fourth sub-frame SF4 by f %. In such an embodiment, the third light source driving signals LBS3 may have a pulse width wider than the length of the sub-frame.

In the same way, each of the first to fourth light source driving signals LBS1, LBS2, LBS3 and LBS4 may have pulse width same or different each other. In addition, each of the first to fourth light source driving signals LBS1, LBS2, LBS3 and LBS4 may have a selectively extended pulse width based on the value of the extension data in the first to fourth dimming data DM1, DM2, DM3 and DM4.

In an exemplary embodiment of a method of driving a display panel, the pulse width of the light source driving signal may be selectively extended based on a local dimming driving, in which brightness level of the light source part 300 is independently driven for each display area based on the brightness level of an image displayed on the display panel 200.

According to an exemplary embodiment, the display panel may be driven based on a data enable signal having converted horizontal and vertical blanking intervals. In an exemplary embodiment, light is sequentially supplied to each of a plurality of display blocks in the 3D mode based on the data enable signal during periods having substantially the same duration, such that display quality of the 3D images is substantially improved. In an exemplary embodiment, pulse width of the light source driving signal may be variously controlled.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a display panel, the method comprising:
applying a data signal to the display panel during a sub-active interval based on a data enable signal; and
blocking the data signal applied to the display panel during a sub-blanking interval,
wherein the data enable signal is activated during the sub-active interval and deactivated during the sub-blanking interval,
wherein a frame is divided into a plurality of sub-frames, and
wherein each of the sub-frames is divided into the sub-active interval and the sub-blanking interval.

2. The method of claim 1, wherein lengths of the sub-frames are substantially the same as each other.

3. The method of claim 2, wherein lengths of the sub-active intervals of the sub-frames are substantially the same as each other.

4. The method of claim 2, wherein lengths of at least two of the sub-active intervals of the sub-frames are different from each other.

5. The method of claim 1, wherein lengths of at least two of the sub-frames are different from each other.

6. The method of claim 5, wherein lengths of the sub-active intervals of the sub-frames are substantially the same as each other.

7. The method of claim 5, wherein lengths of at least two of the sub-active intervals of the sub-frames are different from each other.

8. A method of displaying a three-dimensional (3D) image, the method comprising:
applying a left-eye data signal or a right-eye data signal to a display panel during a sub-active interval based on a data enable signal, wherein a frame is divided into a plurality of sub-frames, and each of the sub-frames is divided into the sub-active interval and a sub-blanking interval; and
sequentially driving a plurality of light emitting blocks of the display panel on a sub-frame-by-sub-frame basis, wherein the light emitting blocks correspond to a plurality of display blocks of the display panel,
wherein the data enable signal is activated during the sub-active interval and deactivated during the sub-blanking interval.

9. The method of claim 8, further comprising:
generating a flag signal, wherein the flag signal is synchronized with the sub-frames and controls a driving period of each of the light emitting blocks; and
generating a dimming signal, wherein the dimming signal is synchronized with the flag signal and controls a brightness level of each of the light emitting blocks on the sub-frame-by-sub-frame basis, and
wherein the dimming signal comprises a plurality of block dimming data,
wherein the block dimming data of a current sub-frame corresponds to the light emitting blocks of a next sub-frame, and
wherein the light emitting blocks are driven based on the dimming signal.

10. The method of claim 9, wherein
the block dimming data of the current sub-frame comprise at least one of a low data and a high data,
the low data turns off the light emitting blocks during the next sub-frame,
the high data turns on the light emitting blocks during the next sub-frame, and
each of the light emitting blocks emit light during the next sub-frame based on a corresponding block dimming data of the block dimming data of the current frame.

11. The method of claim 9, wherein
the block dimming data of the current sub-frame comprise at least one of a low data, a high data and a first extension data,
the low data turns off the light emitting blocks during the next sub-frame,
the high data turns on the light emitting blocks during the next sub-frame,
the first extension data turns on the light emitting blocks during a predetermined latter portion of the next sub-frame, and
at least one of the light emitting blocks emits light during an interval greater than a length of the next sub-frame based on the first extension data.

12. The method of claim 9, wherein
the block dimming data of the current sub-frame comprise at least one of a low data, a high data and a second extension data,
the low data turns off the light emitting blocks during the next sub-frame,
the high data turns on the light emitting blocks during the next sub-frame,
the second extension data turns on the light emitting blocks during a predetermined early portion of the next sub-frame, and
at least one of the light emitting blocks emits light during an interval greater than a length of the next sub-frame based on the second extension data.

13. The method of claim 9, wherein
the block dimming data of the current sub-frame comprise at least one of a low data, a high data, a first extension data and a second extension data,
the low data turns off the light emitting blocks during the next sub-frame,
the high data turns on the light emitting blocks during the next sub-frame,
the first extension data turns on the light emitting blocks during a predetermined latter portion of the next sub-frame,
the second extension data turns on the light emitting blocks during a predetermined early portion of the next sub-frame, and
at least one of the light emitting blocks emits light during an interval greater than a length of the next sub-frame based on the first and second extension data.

14. The method of claim 8, wherein lengths of the sub-frames are substantially the same as each other.

15. A display apparatus comprising:
a display panel;
a data driving part which outputs a data signal to the display panel;
a timing controller which outputs a data signal to the data driving part during a sub-active interval based on a data enable signal, wherein the data enable signal is activated during the sub-active interval and deactivated during a sub-blanking interval, a frame is divided into a plurality of sub-frames, and each of the sub-frames is divided into the sub-active interval and the sub-blanking interval; and
a light source part comprising a plurality of light emitting blocks, wherein the light source sequentially supplies light to a plurality of light emitting blocks of the display panel on a sub-frame-by-sub-frame basis.

16. The display apparatus of claim 15, wherein
the timing controller generates a flag signal and a dimming signal,
the flag signal is synchronized with the sub-frames and controls a driving period of each of the light emitting blocks,
the dimming signal is synchronized with the flag signal and controls a brightness level of each of the light emitting blocks on the sub-frame-by-sub-frame basis,
the dimming signal comprises a plurality of block dimming data, and
the block dimming data of a current sub-frame correspond to the light emitting blocks of a next sub-frame.

17. The display apparatus of claim 16, further comprising:
a light source driving part which drives the light emitting blocks, and
wherein the light source driving part determines a pulse width of each of light source driving signals based on the dimming signal.

18. The display apparatus of claim 17, wherein
the block dimming data of the current sub-frame comprise at least one of a low data and a high data,
the low data turns off the light emitting blocks during the next sub-frame,
the high data turns on the light emitting blocks during the next sub-frame, and
the light source driving part generates the light source driving signals having a pulse width substantially the same as a length of the sub-frames.

19. The display apparatus of claim 18, wherein
the block dimming data further comprise at least one of a first extension data and a second extension data,
the first extension data turns on the light emitting blocks during a predetermined latter portion of the next sub-frame,
the second extension data turns on the light emitting blocks during a predetermined early portion of the next sub-frame, and
the light source driving part generates the light source driving signal having a pulse width greater than the length of the sub-frames based on at least one of the first and second extension data.

20. The display apparatus of claim 15, wherein
the number of the sub-frames corresponds to the number of the light emitting blocks, and
lengths of the sub-frames are substantially the same as each other.
